(19) United States
(12) Patent Application Publication
(10) Pub. No.: US 2026/0086771 A1
(43) Pub. Date: Mar. 26, 2026

(54) SECURITY DEVICE AND METHOD FOR PERFORMING INTEGER MULTIPLICATION OPERATION

(71) Applicant: Samsung Electronics Co., Ltd., Suwon-si (KR)

(72) Inventors: Jaehyeok KIM, Suwon-si (KR); Hyosun HWANG, Suwon-si (KR)

(73) Assignee: Samsung Electronics Co., Ltd., Suwon-si (KR)

(21) Appl. No.: 19/275,360

(22) Filed: Jul. 21, 2025

(30) Foreign Application Priority Data
Sep. 23, 2024 (KR) 10-2024-0128547
Nov. 15, 2024 (KR) 10-2024-0163201

(51) Int. Cl. G06F 7/72; H04L 9/08

(52) U.S. Cl. CPC G06F 7/728; H04L 9/0861

(57) ABSTRACT

A security device including a controller that generates a first calculation input having a second calculation length, from a first input having the first calculation length, and generates a second calculation input having the second calculation length from a second input having the first calculation length, and a Montgomery multiplier that outputs an integer multiplication result between the first input and the second input through Montgomery multiplication between the first calculation input and the second calculation input.

### CROSS-REFERENCE TO RELATED APPLICATIONS

This application claims priority under 35 U.S.C. § 119 to Korean Patent Application No. 10-2024-0128547 filed on Sep. 23, 2024, and No. 10-2024-0163201 filed on Nov. 15, 2024, in the Korean Intellectual Property Office, the disclosures of each of which are incorporated by reference herein in their entireties.

### BACKGROUND

Some example embodiments described herein relate to a method and/or a security device for performing an integer multiplication calculation.

A side-channel attack refers to an attack for analyzing information (e.g., one or more of a computation time, power consumption of a device, electromagnetic waves generated by the device, or the like) generated during the physical implementation of a cryptographic scheme and obtaining information about decryption.

To counter or reduce these side-channel attacks, encryption algorithms such as one or more of the Rivest-Shamir-Adleman (RSA) algorithm, elliptic curve digital signature algorithm (ECDSA), and Edwards-curve digital signature algorithm (EdDSA) are being utilized.

Most of the calculations included in an operation procedure of these encryption algorithms include modular additions and/or multiplications, but there are cases where integer multiplication calculations are used depending on a technique implemented through the encryption algorithm.

### SUMMARY

Some example embodiments may provide a security device that performs integer multiplication calculations in a relatively short time by using a Montgomery multiplier.

According to an embodiment, a security device includes a controller configured to generate a first calculation input from a first input having a first calculation length, the first calculation having a second calculation length, which is greater than or equal to twice the first calculation length, and to generate a second calculation input having the second calculation length from a second input having the first calculation length, and a Montgomery multiplier configured to output an integer multiplication result of the first input and the second input based on a Montgomery multiplication between the first calculation input and the second calculation input. The controller is configured to generate a first medium input having the second calculation length by adding a plurality of first upper bits to the first input, to generate a second medium input having the second calculation length by adding a plurality of second upper bits to the second input, to generate the first calculation input by shifting bits of the first medium input to a left by the first calculation length, and to generate the second calculation input by shifting bits of the second medium input to the left by the first calculation length.

Alternatively or additionally according to some example embodiments, there is provided a method of performing an integer multiplication calculation in a security device. The method may include generating a first medium input from a first input having a first calculation length, the first medium input having a second calculation length, which is greater than or equal to twice the first calculation length, generating a second medium input having the second calculation length from a second input having the first calculation length, generating a first calculation input by shifting first valid bits of the first input among the first medium input to a left by the first calculation length, generating a second calculation input by shifting second valid bits of the second input among the second medium input to the left by the first calculation length, and outputting, by a Montgomery multiplier, an integer multiplication result between the first input and the second input based on a Montgomery multiplication between the first calculation input and the second calculation input.

Alternatively or additionally according to some example embodiments, a security device includes a controller configured to generate a first calculation input from a first input having a first calculation length, and to generate a second calculation input from a second input having the first calculation length, and a Montgomery multiplier configured to output an integer multiplication result between the first input and the second input based on a Montgomery multiplication between the first calculation input and the second calculation input. The first input includes first valid bits corresponding to a first valid length smaller than or equal to half of the first calculation length. The second input includes second valid bits corresponding to the first valid length. The controller is configured to generate the first calculation input by shifting the first valid bits to a left by the first valid length and to generate the second calculation input by shifting the second valid bits to the left by the first valid length.

Alternatively or additionally according to some example embodiments, there is provided a security system including a processor, the processor including a security device configured to execute machine-readable instructions that, when executed by the security device, cause the security system to generate a first calculation input from a first input having a first calculation length, the first calculation input having a second calculation length greater than or equal to twice the first calculation length, and to generate a second calculation input having the second calculation length from a second input having the first calculation length, and to output an integer multiplication result between the first input and the second input based on a Montgomery multiplication between the first calculation input and the second calculation input. The security device is configured to generate a first medium input having the second calculation length by adding a plurality of first upper bits to the first input, generate a second medium input having the second calculation length by adding a plurality of second upper bits to the second input, generate the first calculation input by shifting bits of the first medium input in a most-significant-bit (MSB) direction by the first calculation length, and generate the second calculation input by shifting bits of the second medium input in the MSB direction by the first calculation length.

In some example embodiments, the processor is configured to generate a secure signature according to at least one of an Rivest-Shamir-Adleman (RSA) algorithm, an elliptic curve digital signature algorithm (ECDSA), an Edwards-curve digital signature algorithm (EdDSA), and a post-quantum algorithm, by using the integer multiplication result.

In some examples embodiments, the security system further includes a bus connected to the processor, and a memory connected to the bus and configured to communicate with the processor through the bus.

### BRIEF DESCRIPTION OF THE FIGURES

The above and other objects and features of inventive concepts will become apparent by describing in detail some example embodiments thereof with reference to the accompanying drawings.

FIG. 1 is a block diagram illustrating a security device, according to some example embodiments.

FIG. 2A illustrates a configuration for generating a first calculation input from a first input, according to some example embodiments.

FIG. 2B illustrates a configuration for generating a second calculation input from a second input, according to some example embodiments.

FIG. 2C illustrates a configuration in which a Montgomery multiplier outputs the result of an integer multiplication calculation between a first input and a second input through Montgomery multiplication between a first calculation input and a second calculation input, according to some example embodiments.

FIG. 3A illustrates a configuration for generating a first calculation input from a first input, according to another embodiment.

FIG. 3B illustrates a configuration for generating a second calculation input from a second input, according to another embodiment.

FIG. 3C illustrates a configuration in which a Montgomery multiplier outputs the result of an integer multiplication calculation between a first input and a second input through Montgomery multiplication between a first calculation input and a second calculation input, according to some example embodiments.

FIG. 4A illustrates a configuration for generating a first calculation input from a first input, according to some example embodiments.

FIG. 4B illustrates a configuration for generating a second calculation input from a second input, according to some example embodiments.

FIG. 4C illustrates a configuration in which a Montgomery multiplier outputs the result of an integer multiplication calculation between a first input and a second input through Montgomery multiplication between a first calculation input and a second calculation input, according to some example embodiments.

FIG. 5 is a flowchart illustrating a method, in which a security device outputs a result of an integer multiplication calculation between two different inputs by using a Montgomery multiplier, according to some example embodiments.

FIG. 6A illustrates a configuration for generating a first calculation input from a first input having a first valid length smaller than half of a first calculation length, according to some example embodiments.

FIG. 6B illustrates a configuration for generating a second calculation input from a second input having a first valid length, according to some example embodiments.

FIG. 6C illustrates a configuration in which a Montgomery multiplier outputs the result of an integer multiplication calculation between a first input and a second input through Montgomery multiplication between a first calculation input and a second calculation input, according to some example embodiments.

FIG. 7 is a flowchart showing a method in which a security device outputs a result of an integer multiplication calculation between a first input and a second input, each of which has a first valid length smaller than half of a first calculation length, by using a Montgomery multiplier, according to some example embodiments.

FIG. 8A is a block diagram illustrating a security device, according to some example embodiments.

FIG. 8B is a block diagram illustrating a security device including a bit shifter positioned between a controller and a Montgomery multiplier, according to some example embodiments.

FIG. 9 is a block diagram illustrating a security system including a security device, according to some example embodiments.

### DETAILED DESCRIPTION

Hereinafter, some example embodiments will be described in detail and clearly to such an extent that an ordinary one in the art easily implements some example embodiments.

In the present disclosure, expressions such as “first,” “second,” and the like may refer to various components regardless of order and/or importance, and are only used to distinguish one component from another and do not limit the order or importance of the components.

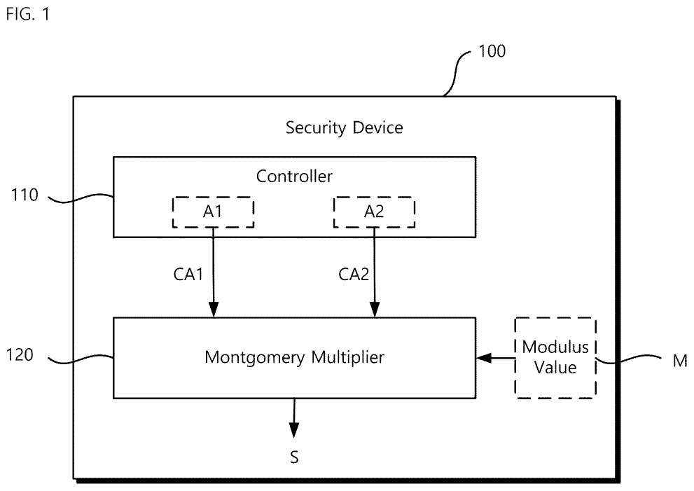

FIG. 1 is a block diagram illustrating a security device, according to some example embodiments.

Referring to FIG. 1, a security device 100 according to some example embodiments may include a controller 110 and a Montgomery multiplier 120.

The security device 100 may include the controller 110 that controls at least some of, e.g., up to the overall operation of the security device 100.

For example, the controller 110 may execute software (and/or a program) to control at least one other component (e.g., the Montgomery multiplier 120) of the security device 100 and may process and may calculate various types of data. The controller 110 may include a central processing device or a microprocessor, and may control the overall operation of the security device 100. Accordingly, the operations performed by the security device 100 may be understood as being performed under the control of the controller 110.

According to some example embodiments, the controller 110 may include, e.g., may include non-transient machine-readable instructions for, an algorithm for controlling the security device 100. For example, the algorithm may be or may include a software code programmed inside the controller 110. Alternatively or additionally, the algorithm may be or may include a hard code, which is hard-coded inside the controller 110, but is not limited thereto.

According to at least one algorithm, the controller 110 may perform at least one of an integer multiplication calculation, a modular exponentiation calculation, and a scalar multiplication calculation by using the Montgomery multiplier 120.

In some example embodiments, the controller 110 may implement at least one of the RSA algorithm, ECDSA, and EdDSA by using the results of calculations using the Montgomery multiplier 120.

In some example embodiments, the security device 100 may encrypt and/or decrypt data, and/or may generate and/or verify a digital signature, through at least some of the above-described algorithms implemented through the controller 110.

For example, the security device 100 may be referenced as a public key accelerator that performs a calculation for generating and/or verifying a public key.

The security device 100 according to some example embodiments may also be referred to as an “encryption device and/or an encryption circuit”.

According to some example embodiments, the controller 110 may generate a first calculation input CA1 from a first input A1.

Here, the first calculation input CA1 may have a calculation length (e.g., a bit length) greater than or equal to twice the calculation length (e.g., the bit length) of the first input A1. For example, when the first input A1 has a calculation length of 128 bits, the first calculation input CA1 may have a calculation length of 256 bits or more.

The calculation length of each of the first input A1 and the first calculation input CA1 may be referenced as a value obtained by multiplying the chunk being the calculation unit of each input, and as the precision of each input.

Moreover, according to some example embodiments, the first input A1 and the first calculation input CA1 may have chunks of the same size. Accordingly, it may be understood that the precision of the first calculation input CA1 has a value greater than or equal to twice that of the first input A1.

For example, when the chunk of the first input A1 is 64 bits and the precision is 2, the calculation length of the first input A1 may be referenced as 128 bits. Alternatively or additionally, when the chunk of the first calculation input CA1 is 64 bits and the precision is 4, the calculation length of the first calculation input CA1 may be referenced as 256 bits.

In some example embodiments, the controller 110 may generate a second calculation input CA2 from a second input A2.

Here, the second calculation input CA2 may have a calculation length greater than or equal to twice the calculation length of the second input A2. For example, when the second input A2 has a calculation length of 128 bits, the second calculation input CA2 may have a calculation length of 256 bits or more.

In more detail, the calculation length of each of the second input A2 and the second calculation input CA2 may be referenced as a value obtained by multiplying the chunk being the calculation unit of each input, and the precision of each input.

Moreover, according to some example embodiments, the second input A2 and the second calculation input CA2 may have chunks of the same size. Accordingly, it may be understood that the precision of the second calculation input CA2 has a value greater than or equal to twice that of the second input A2.

For example, when the chunk of the second input A2 is 64 bits and the precision is 2, the calculation length of the second input A2 may be referenced as 128 bits. In some example embodiments, when the chunk of the second calculation input CA2 is 64 bits and the precision is 4, the calculation length of the second calculation input CA2 may be referenced as 256 bits.

For example, the controller 110 may generate the first calculation input CA1 and the second calculation input CA2 by increasing the calculation length (or precision) of each of the first input A1 and the second input A2, which have a specified calculation length, by more than two times.

In some example embodiments, the security device 100 may include the Montgomery multiplier 120 connected to the controller 110.

According to some example embodiments, the Montgomery multiplier 120 may perform a Montgomery multiplication calculation or a calculation based on the Montgomery multiplication between the first calculation input CA1 and the second calculation input CA2.

In more detail, the Montgomery multiplier 120 may perform a Montgomery multiplication calculation in a Montgomery domain by multiplying the result of the multiplication between the first calculation input CA1 and the second calculation input CA2 by the reciprocal of a Montgomery constant.

Here, the first calculation input CA1 may have or may have included therein a value obtained by multiplying the first input A1 by the square root of the Montgomery constant. In some example embodiments, the second calculation input CA2 may have a value obtained by multiplying the second input A2 by the square root of the Montgomery constant.

Accordingly, the Montgomery multiplier 120 may output an integer multiplication result ‘S’ corresponding to the result of the integer multiplication calculation between the first input A1 and the second input A2 through the Montgomery multiplication calculation between the first calculation input CA1 and the second calculation input CA2.

Here, the integer multiplication result ‘S’ output by the Montgomery multiplier 120 may have a number of bits corresponding to the same length as the first calculation input CA1 and the second calculation input CA2.

For example, the integer multiplication result ‘S’ may have a number of bits corresponding to a length greater than or equal to twice the calculation length of the first input A1 and the second input A2.

Furthermore, the integer multiplication result ‘S’ output by the Montgomery multiplier 120 may have a value less than the modulus value ‘M’. Here, it may be understood that the modulus value ‘M’ is the maximum value of the value output through the Montgomery multiplier 120.

According to some example embodiments, it may be understood that the modulus value ‘M’ illustrated in FIG. 1 is a hard code (or, fixed code) hard-coded inside the security device 100. In some example embodiments, the security device 100 may further include a separate circuit for generating the modulus value ‘M’.

The modulus value ‘M’ according to some example embodiments may have a value greater than a value obtained by multiplying the maximum value of the first calculation input CA1 and the maximum value of the second calculation input CA2.

In this way, the security device 100 may minimize or reduce the impact from and/or probability of cases where the integer multiplication result ‘S’ exceeds the modulus value ‘M’.

Besides, the modulus value ‘M’ according to some example embodiments may have a value smaller than 2 raised to the power of the calculation length of the first calculation input CA1 and/or the second calculation input CA2.

Referring to the above-described configurations, the controller 110 according to some example embodiments may generate the two calculation inputs CA1 and CA2 having a calculation length greater than or equal to twice that of the two inputs A1 and A2.

Moreover, the Montgomery multiplier 120 may output the integer multiplication result ‘S’ corresponding to the result of the integer multiplication calculation between the two inputs A1 and A2 through the Montgomery multiplication calculation between the two calculation inputs CA1 and CA2.

Accordingly, the security device 100 may perform an integer multiplication calculation between the two inputs A1 and A2 by using the Montgomery multiplier 120, which performs the Montgomery multiplication calculation.

In this way, compared to a case where a separate configuration for integer multiplication calculation is provided, the security device 100 according to some example embodiments may be implemented with a relatively small area. If the security device 100 is implemented with a relatively small area based on some example embodiments, then one or more improvements may occur. For example, one or more of a yield, a reliability, a power consumption, or a speed may be improved based on some example embodiments, by using a Montgomery multiplication calculation according to some example embodiments.

Alternatively or additionally, according to some example embodiments, the integer multiplication result ‘S’ output by the Montgomery multiplier 120 may have a length greater than or equal to twice the length of each of the two inputs A1 and A2.

In more detail, the Montgomery multiplier 120 may output the integer multiplication result ‘S’ having a calculation length greater than or equal to twice that of the two inputs A1 and A2, through Montgomery multiplication between the two calculation inputs CA1 and CA2 having a calculation length greater than or equal to twice that of the two inputs A1 and A2.

In this way, the security device 100 according to some example embodiments may minimize or reduce the impact from and/or the probability of cases where the integer multiplication result ‘S’ between the two inputs A1 and A2 exceeds the calculation length (or, the modulus value ‘M’) of the Montgomery calculation. In this way, the security device 100 may improve the accuracy of the integer multiplication calculation.

In some example embodiments, each of the elements included in FIG. 1 may communicate with some or all of the other elements in FIG. 1. For example, elements may communicate in a one-way, a two-way, and/or a multi-way manner (such as a broadcast manner), over a bus such as but not limited to a wireless and/or wired bus, to transmit and/or receive information. The information may be or may include data and/or commands, and may be sent in various manners such as but not limited to digital and/or analog formats, and may be sent and/or received in various other manners such as but not limited to a serial and/or a parallel manner. Example embodiments are not limited thereto.

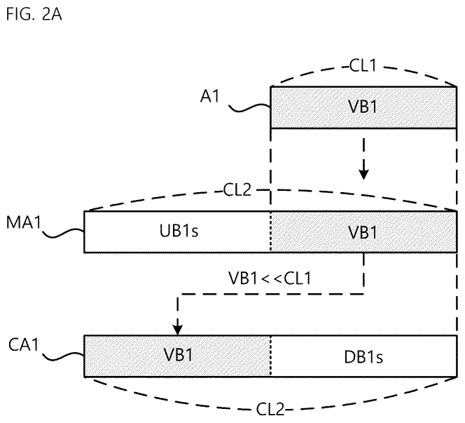

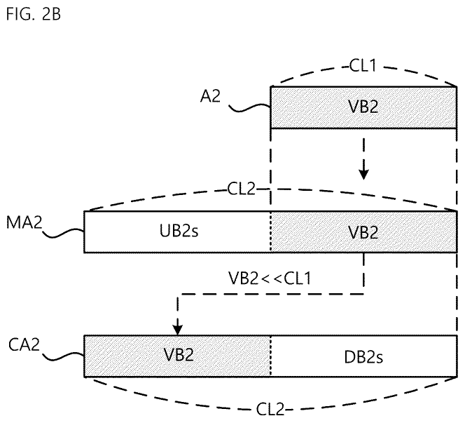

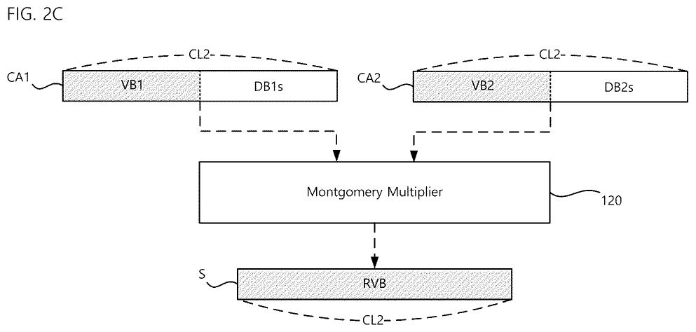

FIG. 2A illustrates a configuration for generating a first calculation input from a first input, according to some example embodiments. FIG. 2B illustrates a configuration for generating a second calculation input from a second input, according to some example embodiments. FIG. 2C illustrates a configuration in which a Montgomery multiplier outputs the result of an integer multiplication calculation between a first input and a second input through Montgomery multiplication between a first calculation input and a second calculation input, according to some example embodiments.

Referring to FIGS. 2A to 2C together, the security device 100 according to some example embodiments may perform an integer multiplication calculation between the two inputs A1 and A2 through a Montgomery multiplication calculation of the Montgomery multiplier 120.

Referring to FIG. 2A, the controller 110 according to some example embodiments may generate a first medium input (or a first sign input) MA1 from the first input A1.

In more detail, the controller 110 may generate the first medium input MA1 having a second calculation length CL2 greater than or equal to twice a first calculation length CL1 from the first input A1 having the first calculation length CL1.

However, for convenience of description below, it is assumed that the second calculation length CL2 is twice the first calculation length CL1.

The controller 110 according to some example embodiments may generate the first medium input MA1 having the second calculation length CL2 by adding a plurality of first upper bits UB1s to the first input A1.

For example, the controller 110 may generate the first medium input MA1 having the second calculation length CL2 by adding the plurality of first upper bits UB1s, of which the number is equal to the number of first valid bits VB1 of the first input A1, to the first input A1.

Here, the plurality of first upper bits UB1s according to some example embodiments may have a value according to the value of the first valid bits VB1.

In more detail, each of the plurality of first upper bits UB1s may have a value according to the value of a sign-bit among the first valid bits VB1.

For example, when a value of a 1-1st valid bit (e.g., a sign-bit) is 1, a value of the 1-1st upper bit of the plurality of first upper bits UB1s may be 1. For another example, when a value of the 1-1st valid bit is 0, the value of the 1-1st upper bit may be 0.

Alternatively or additionally according to some example embodiments, the value of the each of the plurality of first upper bits UB1s can be determined by a value of the sign-bit of the first valid bits VB1 stored separately from the first valid bits VB1.

For example, each of the plurality of first upper bits UB1s according to some example embodiments may have a value output by inputting a value of each of the first valid bits VB1 to a sign function.

However, according to some example embodiments, each of the plurality of first upper bits UB1s may have a value, such as a dynamically determined (or, alternatively, a predetermined) value (e.g., “0”). For example, values of the plurality of first upper bits UB1s are not limited to the examples described above, and may be determined by various types of functions or settings.

Referring to FIG. 2B, the controller 110 according to some example embodiments may generate a second medium input (or a second sign input) MA2 from the second input A2.

In more detail, the controller 110 may generate the second medium input MA2 having the second calculation length CL2 from the second input A2 having the first calculation length CL1.

The controller 110 according to some example embodiments may generate the second medium input MA2 having the second calculation length CL2 by adding a plurality of second upper bits UB2s.

For example, the controller 110 may generate the second medium input MA2 having the second calculation length CL2 by adding the plurality of second upper bits UB2s, of which the number is equal to the number of second valid bits VB2 of the second input A2, to the second input A2.

Here, the plurality of second upper bits UB2s according to some example embodiments may have a value according to the value of the second valid bits VB2.

In more detail, each of the plurality of second upper bits UB2s may have a value according to the value of a sign-bit among the second valid bits VB2.

For example, when a value of a 1-1st valid bit (e.g., a sign-bit) is 1, a value of the 1-1st upper bit of the plurality of second upper bits UB2s may be 1. For another example, when a value of the 1-1st valid bit is 0, the value of the 1-1st upper bit may be 0.

Alternatively or additionally according to some example embodiments, the value of the each of the plurality of second upper bits UB2s can be determined by a value of the sign-bit of the second valid bits VB2 stored separately from the second valid bits VB2.

For example, each of the plurality of second upper bits UB2s according to some example embodiments may have a value output by inputting a value of each of the second valid bits VB2 to a sign function.

However, according to some example embodiments, each of the plurality of second upper bits UB2s may have a predetermined value (e.g., “0”). For example, values of the plurality of second upper bits UB2s are not limited to the examples described above, and may be determined by various types of functions or settings.

Also, referring to FIG. 2A, the controller 110 according to some example embodiments may generate the first calculation input CA1 from the first medium input MA1.

In more detail, the controller 110 may generate the first calculation input CA1 by shifting the first valid bits VB1 included in the first medium input MA1 to a direction corresponding to a more significant bit (MSB) direction, e.g., to the left, by the first calculation length CL1.

Furthermore, the controller 110 may add a plurality of first lower bits DB1s having the first calculation length CL1. Here, for example, each of the plurality of first lower bits DB1s may have a predetermined value (e.g., “0”).

For example, the controller 110 may add the plurality of first lower bits DB1s, in which the number of bits having a value of “0” corresponds to the first calculation length CL1.

For example, the controller 110 may generate the first calculation input CA1 by shifting the first valid bits VB1 to the left by the first calculation length CL1 and adding the plurality of first lower bits DB1s having the first calculation length CL1.

Moreover, according to some example embodiments, the first calculation input CA1 may have a value obtained by multiplying the first input A1 by 2 raised to the power of the first calculation length CL1.

More specifically, as the first valid bits VB1 is shifted to the left by the first calculation length CL1, the first calculation input CA1 may have a value obtained by multiplying the first input A1 by 2 raised to the power of the first calculation length CL1.

For example, a value of the first calculation input CA1 may be referenced based on Equation 1 below.

$$CA 1 = A 1 \times {2}^{CL 1} \qquad [ Equation 1 ]$$

Moreover, a Montgomery constant ‘R’ of the Montgomery multiplier 120 may be defined as a value whose base is 2 and whose exponent is twice the first calculation length CL1. The Montgomery constant ‘R’ may be referenced based on Equation 2 below.

$$R = {2}^{2 \times CL 1} \qquad [ Equation 2 ]$$

Here, the first calculation input CA1 may have a value obtained by multiplying the first input A1 by the square root of the Montgomery constant ‘R’. Accordingly, the first calculation input CA1 may be referenced based on Equation 3.

$$CA 1 = A 1 \times {R}^{\frac{1}{2}} \qquad [ Equation 3 ]$$

Accordingly, the controller 110 may generate the first calculation input CA1 having the second calculation length CL2 and having a value obtained by multiplying the first input A1 by the square root of the Montgomery constant ‘R’.

Moreover, referring to FIG. 2B, the controller 110 according to some example embodiments may generate the second calculation input CA2 from the second medium input MA2.

In more detail, the controller 110 may generate the second calculation input CA2 by shifting the second valid bits VB2 included in the second medium input MA2 to the left by the first calculation length CL1.

Furthermore, the controller 110 may add a plurality of second lower bits DB2s having the first calculation length CL1.

Here, for example, each of the plurality of second lower bits DB2s may have a specific (e.g., a dynamically determined, or alternatively, a predetermined) bit value (e.g., “0”). For examples, the controller 110 may add the plurality of second lower bits DB2s, in which the number of bits having a value of “0” corresponds to the first calculation length CL1.

In some examples the controller 110 may generate the second calculation input CA2 by shifting the second valid bits VB2 to a direction corresponding to the MSB direction, e.g., to the left by the first calculation length CL1 and adding the plurality of second lower bits DB2s having the first calculation length CL1.

Moreover, according to some example embodiments, the second calculation input CA2 may have a value obtained by multiplying the second input A2 by 2 raised to the power of the first calculation length CL1.

More specifically, as the second valid bits VB2 is shifted to the left by the first calculation length CL1, the second calculation input CA2 may have a value obtained by multiplying the second input A2 by 2 raised to the power of the first calculation length CL1.

For example, a value of the second calculation input CA2 may be referenced based on Equation 4 below.

$$CA 2 = A 2 \times {2}^{CL 1} \qquad [ Equation 4 ]$$

Here, the second calculation input CA2 may have a value obtained by multiplying the second input A2 by the square root of the Montgomery constant ‘R’. Accordingly, the second calculation input CA2 may be referenced based on Equation 5.

$$CA 2 = A 2 \times {R}^{\frac{1}{2}} \qquad [ Equation 5 ]$$

Accordingly, the controller 110 may generate the second calculation input CA2 having the second calculation length CL2 and having a value obtained by multiplying the second input A2 by the square root of the Montgomery constant ‘R’.

Referring to FIG. 2C, according to some example embodiments, the Montgomery multiplier 120 may perform a Montgomery multiplication calculation between the first calculation input CA1 and the second calculation input CA2.

In more detail, the Montgomery multiplier 120 may perform a Montgomery multiplication calculation in a Montgomery domain by multiplying the result of the multiplication between the first calculation input CA1 and the second calculation input CA2 by the reciprocal of the Montgomery constant ‘R’.

The Montgomery multiplier 120 may output the integer multiplication result ‘S’ corresponding to the result of the integer multiplication calculation between the first input A1 and the second input A2 through the Montgomery multiplication calculation between the first calculation input CA1 and the second calculation input CA2.

The integer multiplication result ‘S’ according to the Montgomery multiplication calculation performed through the Montgomery multiplier 120 may be referenced by Equation 6 below.

$$S = ( A 1 \times {R}^{\frac{1}{2}} ) \times ( A 2 \times {R}^{\frac{1}{2}} ) \times {R}^{- 1} mod M = A 1 \times A 2 mod A = A 1 \times A 2 \qquad [ Equation 6 ]$$

Referring to the above-described configurations, the controller 110 according to some example embodiments may generate the two calculation inputs CA1 and CA2 by shifting the valid bits VB1 and VB2 respectively corresponding to the two inputs A1 and A2 to the left by the first calculation length CL1.

The calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

Here, the integer multiplication result ‘S’ may include result valid bits RVB having the second calculation length CL2. For example, the result of the integer multiplication calculation between the first input A1 and the second input A2 may be expressed as the result valid bits RVB of the second calculation length CL2.

Through the above-described configurations, the security device 100 may perform an integer multiplication calculation between the two inputs A1 and A2 by using a Montgomery multiplication calculation of the Montgomery multiplier 120.

In this way, compared to a case where a separate configuration for integer multiplication calculation between the two inputs A1 and A2 is provided, the security device 100 according to some example embodiments may be implemented with a relatively small area.

Alternatively or additionally, referring to the above-described configurations, the security device 100 may perform an integer multiplication calculation between the two inputs A1 and A2 by using the internal Montgomery multiplier 120 without any intervention of hardware or software outside the security device 100.

In this way, the security device 100 may improve the security of the encryption algorithm implemented through the security device 100.

Alternatively or additionally, referring to the above-described configurations, the security device 100 may perform an integer multiplication calculation between the two inputs A1 and A2 by performing a Montgomery multiplication calculation once.

Accordingly, compared to a case where the security device 100 converts one of the two inputs A1 and A2 to the Montgomery domain by using the square of the Montgomery constant ‘R’ and performs a Montgomery multiplication calculation between the converted input and the other input, the security device 100 may perform an integer multiplication calculation in a relatively short time.

In some example embodiments, the security device 100 according to some example embodiments may reduce the time required to perform an integer multiplication calculation by using a Montgomery multiplication calculation.

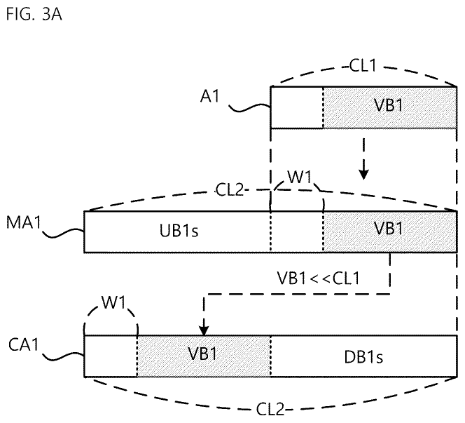

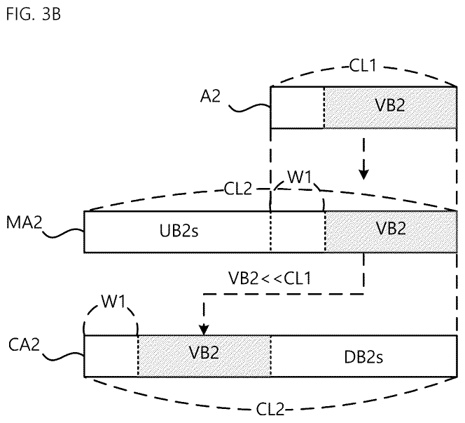

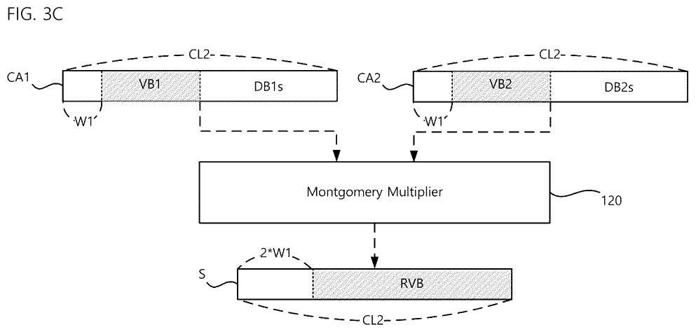

FIG. 3A illustrates a configuration for generating a first calculation input from a first input, according to some example embodiments. FIG. 3B illustrates a configuration for generating a second calculation input from a second input, according to some example embodiments. FIG. 3C illustrates a configuration in which a Montgomery multiplier outputs the result of an integer multiplication calculation between a first input and a second input through Montgomery multiplication between a first calculation input and a second calculation input, according to some example embodiments.

Referring to FIGS. 3A to 3C together, the security device 100 according to some example embodiments may perform an integer multiplication calculation between the two inputs A1 and A2 through a Montgomery multiplication calculation of the Montgomery multiplier 120.

Here, the length of each chunk of the first input A1 and the second input A2 illustrated in FIGS. 3A and 3B may be referenced as being greater than the length of each chunk of the first input A1 and the second input A2 illustrated in FIGS. 2A and 2B by a first additional length W1.

Here, the first additional length W1 according to some example embodiments may be proportional to the precision of each of the first input A1 and the second input A2. For example, the first additional length W1 may increase as the precision of the first input A1 and/or the second input A2 increases.

According to some example embodiments, each of the first valid bits VB1 and the second valid bits VB2 may have a length obtained by subtracting the first additional length W1 from the first calculation length CL1. The first additional length may be greater than or equal to one and less than or equal to a total length of the first valid bits VB1 and/or the second valid bits VB2; example embodiments are not limited thereto.

Referring to FIG. 3A, the controller 110 may generate the first medium input MA1 from the first input A1.

In more detail, the controller 110 may generate the first medium input MA1 having the second calculation length CL2 from the first input A1 having the first calculation length CL1.

The controller 110 according to some example embodiments may generate the first medium input MA1 having the second calculation length CL2 by adding the plurality of first upper bits UB1s.

For example, the controller 110 may generate the first medium input MA1 having the second calculation length CL2 by adding the first upper bits UB1s, of which the number corresponds to the first calculation length CL1, to the first input A1.

Here, each of the first upper bits UB1s according to some example embodiments may have a value according to the value of a sign-bit among the first valid bits VB1.

For example, according to some example embodiments, when a value of the sign-bit among the first valid bits VB1 is 1, a value of each of the plurality of first upper bits UB1s is 1. When the value of the sign-bit is 0, the value of each of the plurality of first upper bits UB1s is 0.

Referring to FIG. 3B, the controller 110 according to some example embodiments may generate the second medium input MA2 from the second input A2.

In more detail, the controller 110 may generate the second medium input MA2 having the second calculation length CL2 from the second input A2 having the first calculation length CL1.

The controller 110 according to some example embodiments may generate the second medium input MA2 having the second calculation length CL2 by adding the plurality of second upper bits UB2s.

For example, the controller 110 may generate the second medium input MA2 having the second calculation length CL2 by adding the plurality of second upper bits UB2s, of which the number corresponds to the first calculation length CL1, to the second input A2.

Here, the plurality of second upper bits UB2s according to some example embodiments may have a value according to the value of a sign-bit among the second valid bits VB2.

For example, according to some example embodiments, when a value of the sign-bit among the second valid bits VB2 is 1, a value of each of the second upper bits UB2s is 1. When the value of the sign-bit is 0, the value of each of the second upper bits UB2s is 0.

Also, referring to FIG. 3A, the controller 110 according to some example embodiments may generate the first calculation input CA1 from the first medium input MA1.

In more detail, the controller 110 may generate the first calculation input CA1 by shifting the first valid bits VB1 included in the first medium input MA1 to the left by the first calculation length CL1.

Furthermore, the controller 110 may add the plurality of first lower bits DB1s having the first calculation length CL1.

Here, for example, each of the plurality of first lower bits of DB1s may have a specific value, such as a dynamically determined (or, alternatively, a predetermined) value (e.g., “0”). For example, the controller 110 may add the plurality of first lower bits DB1s, in which the number of bits having a value of “0” corresponds to the first calculation length CL1.

In some example embodiments, the controller 110 may generate the first calculation input CA1 by shifting the first valid bits VB1 to the left by the first calculation length CL1 and adding the plurality of first lower bits DB1s having the first calculation length CL1.

Moreover, the first calculation input CA1 may have a value obtained by multiplying the first input A1 by 2 raised to the power of the first calculation length CL1.

More specifically, as the first valid bits VB1 is shifted to the left by the first calculation length CL1, the first calculation input CA1 may have a value obtained by multiplying the first input A1 by 2 raised to the power of the first calculation length CL1.

Moreover, the Montgomery constant ‘R’ of the Montgomery multiplier 120 may be defined as a value whose base is 2 and whose exponent is twice the first calculation length CL1.

Accordingly, the first calculation input CA1 may have a value obtained by multiplying the first input A1 by the square root of the Montgomery constant ‘R’.

For example, the controller 110 may generate the first calculation input CA1 having the second calculation length CL2 and having a value obtained by multiplying the first input A1 by the square root of the Montgomery constant ‘R’.

Moreover, referring to FIG. 3B, the controller 110 according to some example embodiments may generate the second calculation input CA2 from the second medium input MA2.

In more detail, the controller 110 may generate the second calculation input CA2 by shifting the second valid bits VB2 included in the second medium input MA2 to the left by the first calculation length CL1.

Furthermore, the controller 110 may add the plurality of second lower bits DB2s having the first calculation length CL1.

Here, for example, each of the plurality of second lower bits of DB2s may have a predetermined value (e.g., “0”). That is, the controller 110 may add the plurality of second lower bits DB2s, in which the number of bits having a value of “0” corresponds to the first calculation length CL1.

For example, the controller 110 may generate the second calculation input CA2 by shifting the second valid bits VB2 to the left by the first calculation length CL1 and adding the plurality of second lower bits DB2s having the first calculation length CL1.

Moreover, according to some example embodiments, the second calculation input CA2 may have a value obtained by multiplying the second input A2 by 2 raised to the power of the first calculation length CL1.

More specifically, as the second valid bits VB2 is shifted in a direction corresponding to an increasing MSB direction, e.g., to the left by the first calculation length CL1, the second calculation input CA2 may have a value obtained by multiplying the second input A2 by 2 raised to the power of the first calculation length CL1.

Accordingly, the second calculation input CA2 may have a value obtained by multiplying the second input A2 by the square root of the Montgomery constant ‘R’.

For example, the controller 110 may generate the second calculation input CA2 having the second calculation length CL2 and having a value obtained by multiplying the second input A2 by the square root of the Montgomery constant ‘R’.

Referring to FIG. 3C, according to some example embodiments, the Montgomery multiplier 120 may perform a Montgomery multiplication calculation between the first calculation input CA1 and the second calculation input CA2.

In more detail, the Montgomery multiplier 120 may perform a Montgomery multiplication calculation in a Montgomery domain by multiplying the result of the multiplication between the first calculation input CA1 and the second calculation input CA2 by the reciprocal of the Montgomery constant ‘R’.

The Montgomery multiplier 120 may output the integer multiplication result ‘S’ being the result of the integer multiplication calculation between the first input A1 and the second input A2 through the Montgomery multiplication calculation between the first calculation input CA1 and the second calculation input CA2.

Here, the integer multiplication result ‘S’ may include the result valid bits RVB having the length obtained by subtracting twice the first additional length W1 from the second calculation length CL2.

For example, the result of the integer multiplication calculation between the first input A1 and the second input A2 may be expressed as the result valid bits RVB having the length obtained by subtracting twice the first additional length W1 from the second calculation length CL2.

Referring to the above-described configurations, the controller 110 according to some example embodiments may generate the two calculation inputs CA1 and CA2 by shifting the valid bits VB1 and VB2 respectively corresponding to the two inputs A1 and A2 to the left by the first calculation length CL1.

The calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

Through at least some of the above-described configurations, the security device 100 may perform an integer multiplication calculation between the two inputs A1 and A2 by using a Montgomery multiplication calculation of the Montgomery multiplier 120.

In this way, compared to a case where a separate configuration for integer multiplication calculation between the two inputs A1 and A2 is provided, the security device 100 according to some example embodiments may be implemented with a relatively small area.

Also, referring to the above-described configurations, the security device 100 may perform an integer multiplication calculation between the two inputs A1 and A2 by performing a Montgomery multiplication calculation once.

For example, compared to the case where the security device 100 converts one of the two inputs A1 and A2 to the Montgomery domain by using the square of the Montgomery constant ‘R’ and performs a Montgomery multiplication calculation between the converted input and the other input, the security device 100 may perform an integer multiplication calculation in a relatively short time.

Accordingly, the security device 100 according to some example embodiments may reduce the time required to perform an integer multiplication calculation by using a Montgomery multiplication calculation.

Moreover, referring to the above-described configurations, when the length of each chunk of the inputs A1 and A2 according to an embodiment increases by the first additional length W1, the length of each of the valid bits VB1 and VB2 in an operation process may be decreased by the first additional length W1.

Furthermore, when the length of each chunk of the inputs A1 and A2 increases by the first additional length W1, the integer multiplication result ‘S’ output by the Montgomery multiplier 120 may include the result valid bits RVB of the length obtained by subtracting twice the first additional length W1 from the second calculation length CL2.

In this way, the security device 100 according to some example embodiments may reduce the possibility of overflow of a bit occurring in an operation process between the first input A1 and the second input A2. Accordingly, the security device 100 according to some example embodiments may improve the accuracy of the integer multiplication calculation.

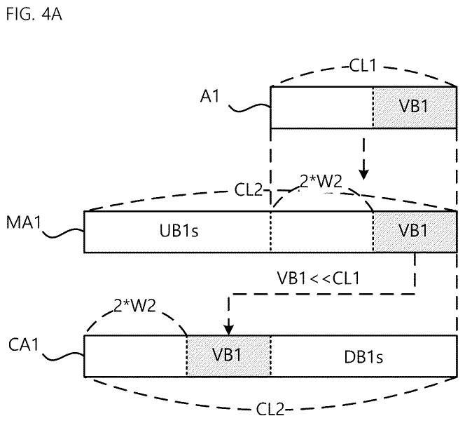

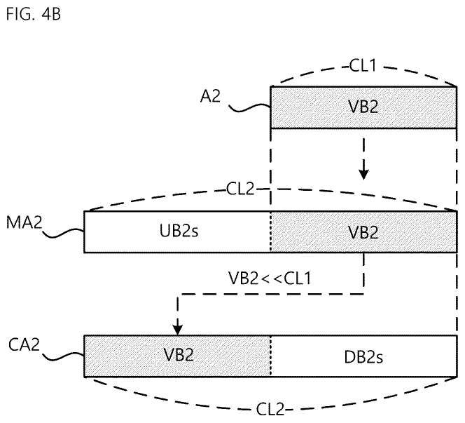

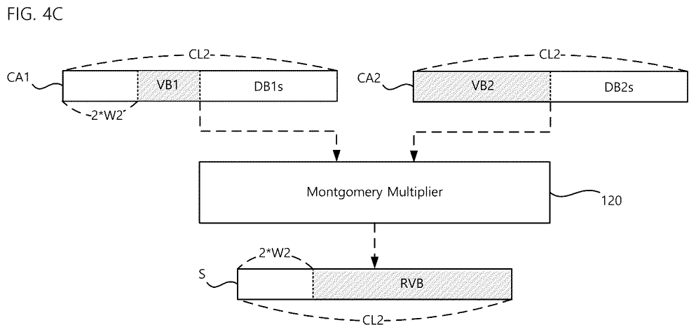

FIG. 4A illustrates a configuration for generating a first calculation input from a first input, according to some example embodiments. FIG. 4B illustrates a configuration for generating a second calculation input from a second input, according to some example embodiments. FIG. 4C illustrates a configuration in which a Montgomery multiplier outputs the result of an integer multiplication calculation between a first input and a second input through Montgomery multiplication between a first calculation input and a second calculation input, according to some example embodiments.

Referring to FIGS. 4A to 4C together, the security device 100 according to some example embodiments may perform an integer multiplication calculation between the two inputs A1 and A2 through a Montgomery multiplication calculation of the Montgomery multiplier 120.

Here, the length of each chunk of the first input A1 and the second input A2 illustrated in FIGS. 4A and 4B may be referenced as being greater than the length of each chunk of the first input A1 and the second input A2 illustrated in FIGS. 2A and 2B by a second additional length W2.

Moreover, for example, the second additional length W2 illustrated in FIGS. 4A to 4C may be referenced as having substantially the same value as the first additional length W1 illustrated in FIGS. 3A to 3C, but is not limited thereto.

Here, the second additional length W2 according to some example embodiments may be proportional to the precision of each of the first input A1 and the second input A2. For example, the second additional length W2 may increase as the precision of the first input A1 and/or the second input A2 increases.

According to some example embodiments, the first valid bits VB1 may have a length obtained by subtracting twice the second additional length W2 from the first calculation length CL1.

Referring to FIG. 4A, the controller 110 may generate the first medium input MA1 from the first input A1.

In more detail, the controller 110 may generate the first medium input MA1 having the second calculation length CL2 from the first input A1 having the first calculation length CL1.

Here, the first medium input MA1 may include the first valid bits VB1 corresponding to a length obtained by subtracting twice the second additional length W2 from the first calculation length CL1.

The controller 110 according to some example embodiments may generate the first medium input MA1 having the second calculation length CL2 by adding the plurality of first upper bits UB1s.

For example, the controller 110 may generate the first medium input MA1 having the second calculation length CL2 by adding the first upper bits UB1s, of which the number corresponds to the first calculation length CL1, to the first input A1.

Here, each of the first upper bits UB1s according to some example embodiments may have a value according to the value of a sign-bit among the first valid bits VB1.

In more detail, when a value of the sign-bit among the first valid bits VB1 is 1, a value of each of the plurality of first upper bits UB1s is 1. When the value of the sign-bit is 0, the value of each of the plurality of first upper bits UB1s is 0.

Referring to FIG. 4B, the controller 110 according to some example embodiments may generate a second medium input MA2 from the second input A2.

In more detail, the controller 110 may generate the second medium input MA2 having the second calculation length CL2 from the second input A2 having the first calculation length CL1.

Here, the second medium input MA2 may include the second valid bits VB2 corresponding to the first calculation length CL1.

The controller 110 according to some example embodiments may generate the second medium input MA2 having the second calculation length CL2 by adding the plurality of second upper bits UB2s.

For example, the controller 110 may generate the second medium input MA2 having the second calculation length CL2 by adding the plurality of second upper bits UB2s, of which the number corresponds to the first calculation length CL1, to the second input A2.

Here, the plurality of second upper bits UB2s according to some example embodiments may have a value according to the value of a sign-bit among the second valid bits VB2.

In more detail, according to some example embodiments, when a value of the sign-bit among the second valid bits VB2 is 1, a value of each of the second upper bits UB2s is 1. When the value of the sign-bit is 0, the value of each of the second upper bits UB2s is 0.

Also, referring to FIG. 4A, the controller 110 according to some example embodiments may generate the first calculation input CA1 from the first medium input MA1.

In more detail, the controller 110 may generate the first calculation input CA1 by shifting the first valid bits VB1 included in the first medium input MA1 to the left by the first calculation length CL1.

Furthermore, the controller 110 may add the plurality of first lower bits DB1s having the first calculation length CL1.

Here, for example, each of the plurality of first lower bits of DB1s may have a predetermined value (e.g., “0”). In some example embodiments, the controller 110 may add the plurality of first lower bits DB1s, in which the number of bits having a value of “0” corresponds to the first calculation length CL1.

For example, the controller 110 may generate the first calculation input CA1 by shifting the first valid bits VB1 to the left by the first calculation length CL1 and adding the plurality of first lower bits DB1s having the first calculation length CL1.

Moreover, the first calculation input CA1 may have a value obtained by multiplying the first input A1 by 2 raised to the power of the first calculation length CL1.

More specifically, as the first valid bits VB1 is shifted to the left by the first calculation length CL1, the first calculation input CA1 may have a value obtained by multiplying the first input A1 by 2 raised to the power of the first calculation length CL1.

Moreover, the Montgomery constant ‘R’ of the Montgomery multiplier 120 may be defined as a value whose base is 2 and whose exponent is twice the first calculation length CL1.

Here, the first calculation input CA1 may have a value obtained by multiplying the first input A1 by the square root of the Montgomery constant ‘R’.

Accordingly, the controller 110 may generate the first calculation input CA1 having the second calculation length CL2 and having a value obtained by multiplying the first input A1 by the square root of the Montgomery constant ‘R’.

For example, a value of the first calculation input CA1 may be referenced based on Equation 7 below.

$$CA 1 = A 1 \times {2}^{( c + 2 \times W 2 ) \times p} \qquad [ Equation 7 ]$$

Here, ‘c’ may denote a length of each chunk of the first input A1 and the second input A2, and ‘p’ may denote the precision of each chunk of the first input A1 and the second input A2.

Moreover, referring to FIG. 4B, the controller 110 according to some example embodiments may generate the second calculation input CA2 from the second medium input MA2.

In more detail, the controller 110 may generate the second calculation input CA2 by shifting the second valid bits VB2 included in the second medium input MA2 to the left by the first calculation length CL1.

Furthermore, the controller 110 may add the plurality of second lower bits DB2s having the first calculation length CL1.

Here, for example, each of the plurality of second lower bits of DB2s may have a predetermined value (e.g., “0”). In some example embodiments, the controller 110 may add the plurality of second lower bits DB2s, in which the number of bits having a value of “0” corresponds to the first calculation length CL1.

For example, the controller 110 may generate the second calculation input CA2 by shifting the second valid bits VB2 to the left by the first calculation length CL1 and adding the plurality of second lower bits DB2s having the first calculation length CL1.

Moreover, according to some example embodiments, the second calculation input CA2 may have a value obtained by multiplying the second input A2 by 2 raised to the power of the first calculation length CL1.

More specifically, as the second valid bits VB2 is shifted to the left by the first calculation length CL1, the second calculation input CA2 may have a value obtained by multiplying the second input A2 by 2 raised to the power of the first calculation length CL1.

Here, the second calculation input CA2 may have a value obtained by multiplying the second input A2 by the square root of the Montgomery constant ‘R’.

Accordingly, the controller 110 may generate the second calculation input CA2 having the second calculation length CL2 and having a value obtained by multiplying the second input A2 by the square root of the Montgomery constant ‘R’.

For example, a value of the second calculation input CA2 may be referenced based on Equation 8 below.

$$CA 2 = A 2 \times {2}^{c \times p} \qquad [ Equation 8 ]$$

Here, ‘c’ may denote a length of each chunk of the first input A1 and the second input A2, and ‘p’ may denote the precision of each chunk of the first input A1 and the second input A2.

Referring to FIG. 4C, according to some example embodiments, the Montgomery multiplier 120 may perform a Montgomery multiplication calculation between the first calculation input CA1 and the second calculation input CA2.

In more detail, the Montgomery multiplier 120 may perform a Montgomery multiplication calculation in a Montgomery domain by multiplying the result of the multiplication between the first calculation input CA1 and the second calculation input CA2 by the reciprocal of the Montgomery constant ‘R’.

The Montgomery multiplier 120 may output the integer multiplication result ‘S’ being the result of the integer multiplication calculation between the first input A1 and the second input A2 through the Montgomery multiplication calculation between the first calculation input CA1 and the second calculation input CA2.

The integer multiplication result ‘S’ according to the Montgomery multiplication calculation performed through the Montgomery multiplier 120 may be referenced by Equation 9 below.

$$S = ( A 1 \times {2}^{( c + 2 \times W 2 ) \times p} ) \times ( A 2 \times {2}^{c \times p} ) \times {R}^{- 1} mod M = A 1 \times A 2 mod A = A 1 \times A 2 \qquad [ Equation 9 ]$$

Here, the integer multiplication result ‘S’ may include the effective result valid bits RVB having the length obtained by subtracting twice the second additional length W2 from the second calculation length CL2.

For example, the result of the integer multiplication calculation between the first input A1 and the second input A2 may be expressed as the result valid bits RVB having the length obtained by subtracting twice the second additional length W2 from the second calculation length CL2.

Referring to the above-described configurations, the controller 110 according to some example embodiments may generate the two calculation inputs CA1 and CA2 by shifting the valid bits VB1 and VB2 respectively corresponding to the two inputs A1 and A2 to the left by the first calculation length CL1.

Accordingly, the calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

Through the above-described configurations, the security device 100 may perform an integer multiplication calculation between the two inputs A1 and A2 by using a Montgomery multiplication calculation of the Montgomery multiplier 120.

In this way, compared to a case where a separate configuration for integer multiplication calculation between the two inputs A1 and A2 is provided, the security device 100 according to some example embodiments may be implemented with a relatively small area.

Alternatively or additionally, referring to the above-described configurations, the security device 100 may perform an integer multiplication calculation between the two inputs A1 and A2 by performing a Montgomery multiplication calculation once.

For example, compared to the case where the security device 100 converts one of the two inputs A1 and A2 to the Montgomery domain by using the square of the Montgomery constant ‘R’ and performs a Montgomery multiplication calculation between the converted input and the other input, the security device 100 may perform an integer multiplication calculation in a relatively short time.

Accordingly, the security device 100 according to some example embodiments may reduce the time required to perform an integer multiplication calculation by using a Montgomery multiplication calculation.

Moreover, referring to the above configurations, when the length of each chunk of the two inputs A1 and A2 increases, the security device 100 may limit the valid length of the integer multiplication result ‘S’ between the two inputs A1 and A2 by twice the increase in the chunk length.

In this way, the security device 100 according to some example embodiments may reduce the possibility of overflow of a bit occurring in an operation process between the first input A1 and the second input A2. Accordingly, the security device 100 may improve the accuracy of the integer multiplication calculation.

Moreover, referring to the above-described configurations, when the length of each chunk of the inputs A1 and A2 has a value increased by the second additional length W2, one (e.g., the first valid bits VB1) of the valid bits VB1 and VB2 in a computation process may have a length obtained by subtracting twice the second additional length W2 from the first calculation length CL1.

For example, when the length of each chunk of the two inputs A1 and A2 increases, the security device 100 according to some example embodiments may limit the length of valid bits of one of the two inputs A1 and A2 by twice the amount of the increase.

In this way, the security device 100 according to some example embodiments may reduce the time and/or resources required to or used to perform a calculation that limits the valid length of each of the two inputs A1 and A2 by the increase amount of the chunk length.

For example, compared to a case where the valid length of each of the two inputs A1 and A2 is limited by the increase amount of the chunk length, the security device 100 according to the embodiment of the present disclosure may perform the calculation with relatively less time and/or resources.

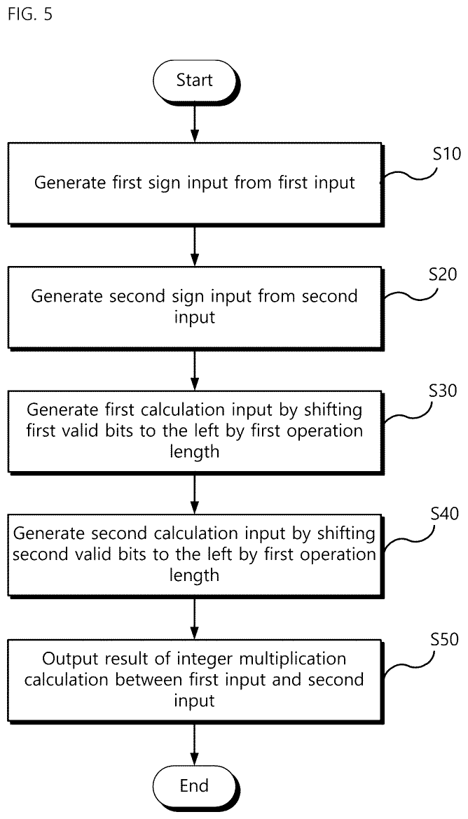

FIG. 5 is a flowchart illustrating a method, in which a security device outputs a result of an integer multiplication calculation between two different inputs by using a Montgomery multiplier, according to some example embodiments.

Referring to FIG. 5, the security device 100 according to some example embodiments may perform an integer multiplication calculation between the two inputs A1 and A2 through a Montgomery multiplication calculation of the Montgomery multiplier 120. The integer multiplication calculation may be impractical or impossible to perform in the human mind.

In operation S10, the controller 110 according to some example embodiments may generate a first medium input MA1 from the first input A1.

In more detail, the controller 110 may generate the first medium input MA1 having the second calculation length CL2 greater than or equal to twice the first calculation length CL1 from the first input A1 having the first calculation length CL1.

The controller 110 according to some example embodiments may generate the first medium input MA1 having the second calculation length CL2 by adding the plurality of first upper bits UB1s to the first input A1.

For example, the controller 110 may generate the first medium input MA1 having the second calculation length CL2 by adding the plurality of first upper bits UB1s, of which the number corresponds to the first calculation length CL1, to the first input A1.

Here, each of the plurality of first upper bits UB1s according to some example embodiments may have a value according to the value of a sign-bit among the first valid bits VB1.

For example, when a value of the sign-bit among the first valid bits VB1 is 0, a value of each of the plurality of first upper bits UB1s is 1. When the value of the sign-bit is 0, the value of each of the plurality of first upper bits UB1s is 0.

That is, the controller 110 may generate the first medium input MA1 having the second calculation length CL2 by adding the first upper bits UB1s, of which the number corresponds to the first calculation length CL1, to the first input A1 having the first calculation length CL1.

In operation S20, the controller 110 according to some example embodiments may generate a second medium input MA2 from the second input A2.

In more detail, the controller 110 may generate the second medium input MA2 having the second calculation length CL2 greater than or equal to twice the first calculation length CL1 from the second input A2 having the first calculation length CL1.

The controller 110 according to some example embodiments may generate the second medium input MA2 having the second calculation length CL2 by adding the plurality of second upper bits UB2s to the second input A2.

For example, the controller 110 may generate the second medium input MA2 having the second calculation length CL2 by adding the plurality of second upper bits UB2s, of which the number corresponds to the first calculation length CL1, to the second input A2.

Here, each of the plurality of second upper bits UB2s according to some example embodiments may have a value according to the value of a sign-bit among the second valid bits VB2.

In more detail, when a value of the sign-bit among the second valid bits VB2 is 1, a value of each of the plurality of second upper bits UB2s is 1. When the value of the sign-bit is 0, the value of each of the plurality of second upper bits UB2s is 0.

That is, the controller 110 may generate the second medium input MA2 having the second calculation length CL2 by adding the second upper bits UB2s, of which the number corresponds to the first calculation length CL1, to the second input A2 having the first calculation length CL1.

However, the order in which operation S10 and operation S20 are performed is not limited to the order according to the drawing. According to some example embodiments, operation S10 and operation S20 may be performed simultaneously, or operation S20 may be performed before operation S10.

In operation S30, the controller 110 according to some example embodiments may generate the first calculation input CA1 by shifting the first valid bits VB1 to the left by the first calculation length CL1.

In more detail, the controller 110 may generate the first calculation input CA1 by shifting the first valid bits VB1 included in the first medium input MA1 to the left by the first calculation length CL1.

Furthermore, the controller 110 may add the plurality of first lower bits DB1s having the first calculation length CL1.

Here, for example, each of the plurality of first lower bits of DB1s may have a predetermined value (e.g., “0”). That is, the controller 110 may add the plurality of first lower bits DB1s, in which the number of bits having a value of “0” corresponds to the first calculation length CL1.

That is, the controller 110 may generate the first calculation input CA1 by shifting the first valid bits VB1 to the left by the first calculation length CL1 and adding the plurality of first lower bits DB1s having the first calculation length CL1.

The first calculation input CA1 may have a value obtained by multiplying the first input A1 by 2 raised to the power of the first calculation length CL1.

More specifically, as the first valid bits VB1 is shifted to the left by the first calculation length CL1, the first calculation input CA1 may have a value obtained by multiplying the first input A1 by 2 raised to the power of the first calculation length CL1.

Moreover, the Montgomery constant ‘R’ of the Montgomery multiplier 120 may be defined as a value whose base is 2 and whose exponent is twice the first calculation length CL1.

Accordingly, the first calculation input CA1 may have a value obtained by multiplying the first input A1 by the square root of the Montgomery constant ‘R’.

That is, the controller 110 may generate the first calculation input CA1 having the second calculation length CL2 and having a value obtained by multiplying the first input A1 by the square root of the Montgomery constant ‘R’.

In operation S40, the controller 110 according to some example embodiments may generate the second calculation input CA2 by shifting the second valid bits VB2 to the left by the first calculation length CL1.

In more detail, the controller 110 may generate the second calculation input CA2 by shifting the second valid bits VB2 included in the second medium input MA2 to the left by the first calculation length CL1.

Furthermore, the controller 110 may add the plurality of second lower bits DB2s having the first calculation length CL1.

Here, for example, each of the plurality of second lower bits of DB2s may have a predetermined value (e.g., “0”). That is, the controller 110 may add the plurality of second lower bits DB2s, in which the number of bits having a value of “0” corresponds to the first calculation length CL1.

That is, the controller 110 may generate the second calculation input CA2 by shifting the second valid bits VB2 to the left by the first calculation length CL1 and adding the plurality of second lower bits DB2s having the first calculation length CL1.

The second calculation input CA2 may have a value obtained by multiplying the second input A2 by 2 raised to the power of the first calculation length CL1.

More specifically, as the second valid bits VB2 is shifted to the left by the first calculation length CL1, the second calculation input CA2 may have a value obtained by multiplying the second input A2 by 2 raised to the power of the first calculation length CL1.

Accordingly, the second calculation input CA2 may have a value obtained by multiplying the second input A2 by the square root of the Montgomery constant ‘R’.

That is, the controller 110 may generate the second calculation input CA2 having the second calculation length CL2 and having a value obtained by multiplying the second input A2 by the square root of the Montgomery constant ‘R’.

However, the order in which operation S30 and operation S40 are performed is not limited to the order according to the drawing. According to some example embodiments, operation S30 and operation S40 may be performed simultaneously, or operation S30 may be performed before operation S40.

In operation S50, the Montgomery multiplier 120 according to some example embodiments may output the integer multiplication result ‘S’ between the first input A1 and the second input A2.

According to some example embodiments, the Montgomery multiplier 120 may perform a Montgomery multiplication calculation between the first calculation input CA1 and the second calculation input CA2.

In more detail, the Montgomery multiplier 120 may perform a Montgomery multiplication calculation in a Montgomery domain by multiplying the result of the multiplication between the first calculation input CA1 and the second calculation input CA2 by the reciprocal of the Montgomery constant ‘R’.

The Montgomery multiplier 120 may output the integer multiplication result ‘S’ being the result of the integer multiplication calculation between the first input A1 and the second input A2 through the Montgomery multiplication calculation between the first calculation input CA1 and the second calculation input CA2.

Referring to the above-described configurations, the controller 110 according to some example embodiments may generate the two calculation inputs CA1 and CA2 by shifting the valid bits VB1 and VB2 respectively corresponding to the two inputs A1 and A2 to the left by the first calculation length CL1. Accordingly, the calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

Through the above-described configurations, the security device 100 may perform an integer multiplication calculation between the two inputs A1 and A2 by using a Montgomery multiplication calculation of the Montgomery multiplier 120.

In this way, compared to a case where a separate configuration for integer multiplication calculation between the two inputs A1 and A2 is provided, the security device 100 according to some example embodiments may be implemented with a relatively small area.

Also, referring to the above-described configurations, the security device 100 may perform an integer multiplication calculation between the two inputs A1 and A2 by performing a Montgomery multiplication calculation once.

In other words, compared to the case where the security device 100 converts one of the two inputs A1 and A2 to the Montgomery domain by using the square of the Montgomery constant ‘R’ and performs a Montgomery multiplication calculation between the converted input and the other input, the security device 100 may perform an integer multiplication calculation in a relatively short time.

In other words, the security device 100 according to some example embodiments may reduce the time required to perform an integer multiplication calculation by using a Montgomery multiplication calculation.

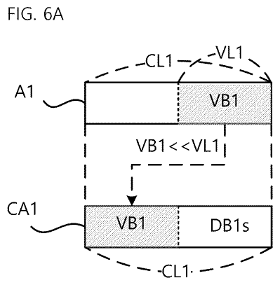

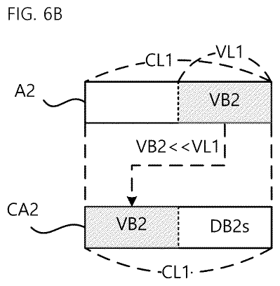

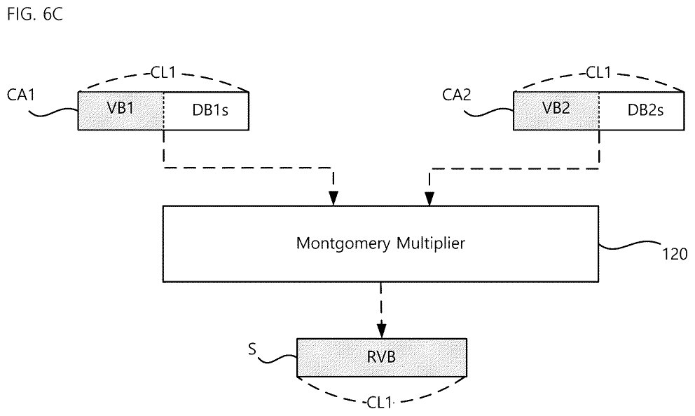

FIG. 6A illustrates a configuration for generating a first calculation input from a first input having a first valid length smaller than half of a first calculation length, according to some example embodiments. FIG. 6B illustrates a configuration for generating a second calculation input from a second input having a first valid length, according to some example embodiments. FIG. 6C illustrates a configuration in which a Montgomery multiplier outputs the result of an integer multiplication calculation between a first input and a second input through Montgomery multiplication between a first calculation input and a second calculation input, according to some example embodiments.

Referring to FIGS. 6A to 6C together, the security device 100 according to some example embodiments may perform an integer multiplication calculation between the two inputs A1 and A2 through a Montgomery multiplication calculation of the Montgomery multiplier 120.

Referring to FIG. 6A, the first input A1 according to some example embodiments may include the first valid bits VB1 of which the number corresponds to the first valid length VL1. Moreover, referring to FIG. 6B, the second input A2 according to some example embodiments may include the second valid bits VB2, of which the number corresponds to the first valid length VL1.

Here, the first valid length VL1 may be smaller than or equal to half of the first calculation length CL1. However, for convenience of description below, it is assumed and described that the first valid length VL1 is half of the first calculation length CL1.

Referring to FIG. 6A, the controller 110 may generate the first calculation input CA1 from the first input A1.

In more detail, the controller 110 may generate the first calculation input CA1 by shifting the first valid bits VB1 included in the first input A1 to the left by the first valid length VL1.

Moreover, the controller 110 may add the plurality of first lower bits DB1s of which the number corresponds to the first valid length VL1.

Here, for example, each of the plurality of first lower bits of DB1s may have a predetermined value (e.g., “0”). That is, the controller 110 may add the plurality of first lower bits DB1s, in which the number of bits having a value of “0” corresponds to the first valid length VL1.

That is, the controller 110 may generate the first calculation input CA1 by shifting the first valid bits VB1 to the left by the first valid length VL1 and adding the plurality of first lower bits DB1s having the first valid length VL1.

Here, the first calculation input CA1 may have a value obtained by multiplying the first input A1 by 2 raised to the power of the first calculation length CL1.

More specifically, as the first valid bits VB1 is shifted to the left by the first calculation length CL1, the first calculation input CA1 may have a value obtained by multiplying the first input A1 by 2 raised to the power of the first calculation length CL1.

Moreover, the Montgomery constant ‘R’ of the Montgomery multiplier 120 may be defined as a value whose base is 2 and whose exponent is the first calculation length CL1.

Accordingly, the first calculation input CA1 may have a value obtained by multiplying the first input A1 by the square root of the Montgomery constant ‘R’.

That is, the controller 110 may generate the first calculation input CA1 having the first calculation length CL1 and having a value obtained by multiplying the first input A1 (or the first valid bits VB1) by the square root of the Montgomery constant ‘R’.

Moreover, referring to FIG. 6B, the controller 110 according to some example embodiments may generate the second calculation input CA2 from the second input A2.

In more detail, the controller 110 may generate the second calculation input CA2 by shifting the second valid bits VB2 included in the second input A2 to the left by the first valid length VL1.

Furthermore, the controller 110 may add the plurality of second lower bits DB2s having the first valid length VL1.

Here, for example, each of the plurality of second lower bits of DB2s may have a predetermined value (e.g., “0”). That is, the controller 110 may add the plurality of second lower bits DB2s, in which the number of bits having a value of “0” corresponds to the first valid length VL1.

That is, the controller 110 may generate the second calculation input CA2 by shifting the second valid bits VB2 to the left by the first valid length VL1 and adding the plurality of second lower bits DB2s having the first valid length VL1.

Moreover, according to some example embodiments, the second calculation input CA2 may have a value obtained by multiplying the second input A2 by 2 raised to the power of the first valid length VL1.

More specifically, as the second valid bits VB2 is shifted to the left by the first valid length VL1, the second calculation input CA2 may have a value obtained by multiplying the second input A2 by 2 raised to the power of the first valid length VL1.

Accordingly, the second calculation input CA2 may have a value obtained by multiplying the second input A2 by the square root of the Montgomery constant ‘R’.

That is, the controller 110 may generate the second calculation input CA2 having the first calculation length CL1 and having a value obtained by multiplying the second input A2 (or the second valid bits VB2) by the square root of the Montgomery constant ‘R’.

Referring to FIG. 6C, according to some example embodiments, the Montgomery multiplier 120 may perform a Montgomery multiplication calculation between the first calculation input CA1 and the second calculation input CA2.

In more detail, the Montgomery multiplier 120 may perform a Montgomery multiplication calculation in a Montgomery domain by multiplying the result of the multiplication between the first calculation input CA1 and the second calculation input CA2 by the reciprocal of the Montgomery constant ‘R’.

The Montgomery multiplier 120 may output the integer multiplication result ‘S’ being the result of the integer multiplication calculation between the first input A1 and the second input A2 through the Montgomery multiplication calculation between the first calculation input CA1 and the second calculation input CA2.

Here, the integer multiplication result ‘S’ may have a length (e.g., the first calculation length CL1) corresponding to twice the first valid length VL1.

That is, the result of the integer multiplication calculation between the first input A1 and the second input A2 may include the result valid bits RVB having a length (e.g., the first calculation length CL1) corresponding to twice the first valid length VL1.

Referring to the above-described configurations, the controller 110 according to some example embodiments may generate the two calculation inputs CA1 and CA2 by shifting the valid bits VB1 and VB2 respectively corresponding to the two inputs A1 and A2 to the left by the first valid length VL1.

The calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

Through the above-described configurations, the security device 100 may perform an integer multiplication calculation between the two inputs A1 and A2 by using a Montgomery multiplication calculation of the Montgomery multiplier 120.

In this way, compared to a case where a separate configuration for integer multiplication calculation between the two inputs A1 and A2 is provided, the security device 100 according to some example embodiments may be implemented with a relatively small area.

Also, referring to the above-described configurations, the security device 100 may perform an integer multiplication calculation between the two inputs A1 and A2 by performing a Montgomery multiplication calculation once.

In other words, compared to the case where the security device 100 converts one of the two inputs A1 and A2 to the Montgomery domain by using the square of the Montgomery constant ‘R’ and performs a Montgomery multiplication calculation between the converted input and the other input, the security device 100 may perform an integer multiplication calculation in a relatively short time.

Accordingly, the security device 100 according to some example embodiments may reduce the time required to perform an integer multiplication calculation by using a Montgomery multiplication calculation.

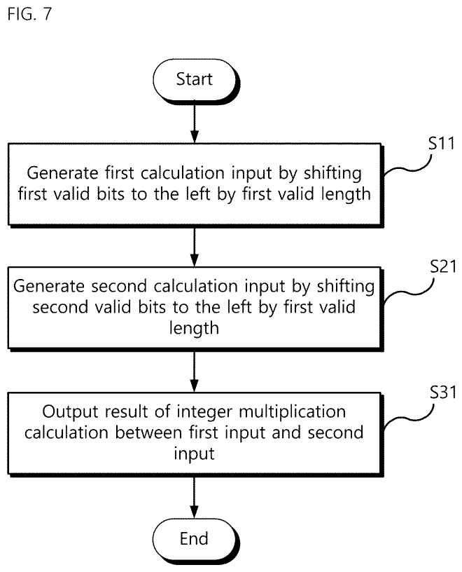

FIG. 7 is a flowchart showing a method in which a security device outputs a result of an integer multiplication calculation between a first input and a second input, each of which has a first valid length smaller than half of a first calculation length, by using a Montgomery multiplier, according to some example embodiments.

Referring to FIG. 5, the security device 100 according to some example embodiments may perform an integer multiplication calculation between the two inputs A1 and A2 through a Montgomery multiplication calculation of the Montgomery multiplier 120.

Here, each of the first input A1 and the second input A2 may include valid bits, of which the number corresponds to the first valid length VL1 corresponding to half of the first calculation length CL1.

For example, the first input A1 may include the first valid bits VB1 of which the number corresponds to the first valid length VL1. Moreover, the second input A2 may include the second valid bits VB2 of which the number corresponds to the first valid length VL1.

In operation S11, the controller 110 according to some example embodiments may generate the first calculation input CA1 from the first input A1.

In more detail, the controller 110 may generate the first calculation input CA1 by shifting the first valid bits VB1 included in the first input A1 to the left by the first valid length VL1.

Moreover, the controller 110 may add the plurality of first lower bits DB1s of which the number corresponds to the first valid length VL1.

Here, for example, each of the plurality of first lower bits of DB1s may have a predetermined value (e.g., “0”). That is, the controller 110 may add the plurality of first lower bits DB1s, in which the number of bits having a value of “0” corresponds to the first valid length VL1.

That is, the controller 110 may generate the first calculation input CA1 by shifting the first valid bits VB1 to the left by the first valid length VL1 and adding the plurality of first lower bits DB1s having the first valid length VL1.

Here, the first calculation input CA1 may have a value obtained by multiplying the first input A1 by 2 raised to the power of the first calculation length CL1.

More specifically, as the first valid bits VB1 is shifted to the left by the first calculation length CL1, the first calculation input CA1 may have a value obtained by multiplying the first input A1 by 2 raised to the power of the first calculation length CL1.

Moreover, the Montgomery constant ‘R’ of the Montgomery multiplier 120 may be defined as a value whose base is 2 and whose exponent is the first calculation length CL1.

Accordingly, the first calculation input CA1 may have a value obtained by multiplying the first input A1 by the square root of the Montgomery constant ‘R’.

That is, the controller 110 may generate the first calculation input CA1 having the first calculation length CL1 and having a value obtained by multiplying the first input A1 (or the first valid bits VB1) by the square root of the Montgomery constant ‘R’.

In operation S21, the controller 110 according to some example embodiments may generate the second calculation input CA2 from the second input A2.

In more detail, the controller 110 may generate the second calculation input CA2 by shifting the second valid bits VB2 included in the second input A2 to the left by the first valid length VL1.

Furthermore, the controller 110 may add the plurality of second lower bits DB2s having the first valid length VL1.

Here, for example, each of the plurality of second lower bits of DB2s may have a predetermined value (e.g., “0”). That is, the controller 110 may add the plurality of second lower bits DB2s, in which the number of bits having a value of “0” corresponds to the first valid length VL1.

That is, the controller 110 may generate the second calculation input CA2 by shifting the second valid bits VB2 to the left by the first valid length VL1 and adding the plurality of second lower bits DB2s having the first valid length VL1.

Moreover, according to some example embodiments, the second calculation input CA2 may have a value obtained by multiplying the second input A2 by 2 raised to the power of the first valid length VL1.

More specifically, as the second valid bits VB2 is shifted to the left by the first valid length VL1, the second calculation input CA2 may have a value obtained by multiplying the second input A2 by 2 raised to the power of the first valid length VL1.

Accordingly, the second calculation input CA2 may have a value obtained by multiplying the second input A2 by the square root of the Montgomery constant ‘R’.

That is, the controller 110 may generate the second calculation input CA2 having the first calculation length CL1 and having a value obtained by multiplying the second input A2 (or the second valid bits VB2) by the square root of the Montgomery constant ‘R’.

In operation S31, the Montgomery multiplier 120 according to some example embodiments may perform a Montgomery multiplication calculation between the first calculation input CA1 and the second calculation input CA2.

In more detail, the Montgomery multiplier 120 may perform a Montgomery multiplication calculation in a Montgomery domain by multiplying the result of the multiplication between the first calculation input CA1 and the second calculation input CA2 by the reciprocal of the Montgomery constant ‘R’.

The Montgomery multiplier 120 may output the integer multiplication result ‘S’ being the result of the integer multiplication calculation between the first input A1 and the second input A2 through the Montgomery multiplication calculation between the first calculation input CA1 and the second calculation input CA2.

Here, the integer multiplication result ‘S’ may have a length (e.g., the first calculation length CL1) corresponding to twice the first valid length VL1.

Referring to the above-described configurations, the controller 110 according to some example embodiments may generate the two calculation inputs CA1 and CA2 by shifting the valid bits VB1 and VB2 respectively corresponding to the two inputs A1 and A2 to the left by the first valid length VL1.

Accordingly, the calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

Through the above-described configurations, the security device 100 may perform an integer multiplication calculation between the two inputs A1 and A2 by using a Montgomery multiplication calculation of the Montgomery multiplier 120.

In this way, compared to a case where a separate configuration for integer multiplication calculation between the two inputs A1 and A2 is provided, the security device 100 according to some example embodiments may be implemented with a relatively small area.

Also, referring to the above-described configurations, the security device 100 may perform an integer multiplication calculation between the two inputs A1 and A2 by performing a Montgomery multiplication calculation once.

In other words, compared to the case where the security device 100 converts one of the two inputs A1 and A2 to the Montgomery domain by using the square of the Montgomery constant ‘R’ and performs a Montgomery multiplication calculation between the converted input and the other input, the security device 100 may perform an integer multiplication calculation in a relatively short time.

Accordingly, the security device 100 according to some example embodiments may reduce the time required to perform an integer multiplication calculation by using a Montgomery multiplication calculation.

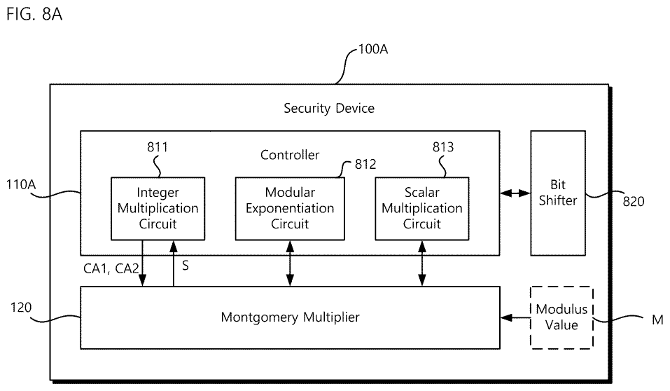

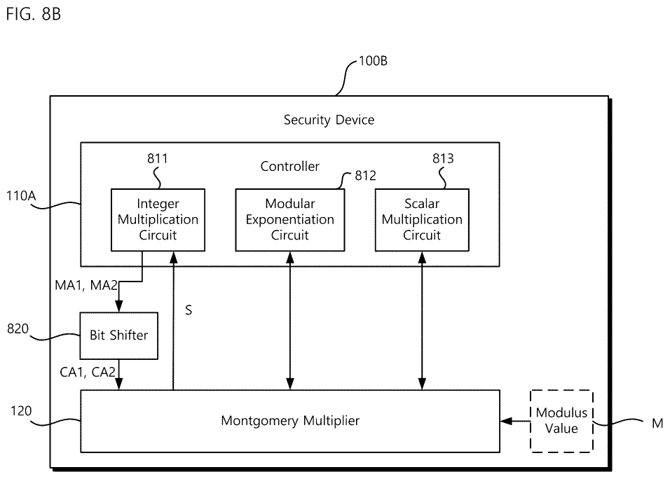

FIG. 8A is a block diagram illustrating a security device, according to some example embodiments. FIG. 8B is a block diagram illustrating a security device including a bit shifter positioned between a controller and a Montgomery multiplier, according to some example embodiments.

Referring to FIGS. 8A and 8B together, each of security devices 100A or 100B according to some example embodiments may include a controller 110A, the Montgomery multiplier 120, and a bit shifter 820.

Here, the security device 100A illustrated in FIG. 8A and the security device 100B illustrated in FIG. 8B may be understood as examples of the security device 100 illustrated in FIG. 1. Accordingly, the same reference numerals are used for components the same or substantially the same as the above-described components, and descriptions the same as the above-described descriptions are omitted to avoid redundancy.

According to some example embodiments, the controller 110A may include an integer multiplication circuit 811, a modular exponentiation circuit 812, and a scalar multiplication circuit 813.

In more detail, the controller 110A may include the integer multiplication circuit 811 that controls an integer multiplication calculation between the two inputs A1 and A2.

According to some example embodiments, the integer multiplication circuit 811 may perform the integer multiplication calculation between the two inputs A1 and A2 by using the Montgomery multiplier 120.

In more detail, the integer multiplication circuit 811 may generate the two calculation inputs CA1 and CA2 by shifting the valid bits VB1 and VB2 respectively corresponding to the two inputs A1 and A2 to the left by the first calculation length CL1.

Here, the integer multiplication circuit 811 may shift the valid bits VB1 and VB2 respectively corresponding to the two inputs A1 and A2 to the left by the first calculation length CL1 by using the bit shifter 820.

For example, the integer multiplication circuit 811 may shift the first valid bits VB1 of the first input A1 to the left by the first calculation length CL1 by using the bit shifter 820. Moreover, after shifting the first valid bits VB1, the integer multiplication circuit 811 may shift the second valid bits VB2 of the second input A2 to the left by the first calculation length CL1 by using the bit shifter 820.

However, for another example, the bit shifter 820 may be composed of a plurality of bit shifting circuits. Accordingly, the integer multiplication circuit 811 may shift the valid bits VB1 and VB2 respectively corresponding to the two inputs A1 and A2 to the left by the first calculation length CL1 by using each of the plurality of bit shifting circuits included in the bit shifter 820. That is, the integer multiplication circuit 811 may simultaneously shift at least some of the first valid bits VB1 and the second valid bits VB2 by using the bit shifter 820.

Referring to FIG. 8A, the controller 110A (or, the integer multiplication circuit 811) according to some example embodiments may transmit the first calculation input CA1 and the second calculation input CA2, which are generated by shifting the valid bits VB1 and VB2 to the left by the first calculation length CL1 through the bit shifter 820, to the Montgomery multiplier 120.

Referring to FIG. 8B, in another embodiment, the controller 110B (or the integer multiplication circuit 811) may transmit the first medium input MA1 and the second medium input MA2 to the bit shifter 820. Furthermore, the bit shifter 820 may generate the first calculation input CA1 and the second calculation input CA2 by shifting the valid bits VB1 and VB2 included in the medium inputs MA1 and MA2 to the left by the first calculation length CL1, respectively. Moreover, the bit shifter 820 may send the first calculation input CA1 and the second calculation input CA2 to the Montgomery multiplier 120.

Here, the Montgomery constant ‘R’ of the Montgomery multiplier 120 may be defined as a value whose base is 2 and whose exponent is twice the first calculation length CL1.

Accordingly, the calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

Moreover, the controller 110A may include the modular exponentiation circuit 812 that performs a modular exponentiation calculation.

In more detail, the modular exponentiation circuit 812 may perform a modular exponentiation calculation that calculates the power of input data by using the Montgomery multiplier 120.

Also, the controller 110A may include the scalar multiplication circuit 813 that performs a scalar multiplication calculation. In more detail, the scalar multiplication circuit 813 may perform a scalar multiplication calculation that multiplies vector data by the absolute value of a scalar.

According to some example embodiments, the controller 110A may implement an encryption algorithm based on results of at least some of an integer multiplication calculation, a modular exponentiation calculation, and a scalar multiplication calculation.

For example, the controller 110A may implement at least one algorithm of an RSA algorithm, an ECDSA, an EdDSA, or a post-quantum algorithm such as one based on lattices; the algorithm may be based on results of at least some of the integer multiplication calculation, the modular exponentiation calculation, and the scalar multiplication calculation.

Referring to the above-described configurations, the security devices 100A and 100B according to some example embodiments may perform calculations required to implement the encryption algorithm using the Montgomery multiplier 120.

In this way, compared to a case where a separate component (or circuit) for each of calculations (e.g., an integer multiplication calculation) for implementing an encryption algorithm is provided, the security devices 100A and 100B according to some example embodiments may be implemented with a relatively small area.

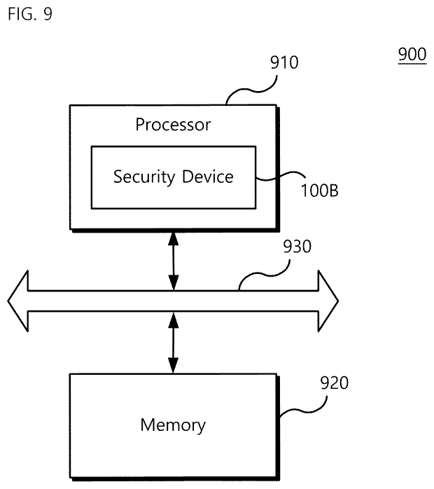

FIG. 9 is a block diagram illustrating a security system including a security device, according to some example embodiments.

Referring to FIG. 9, a security system 900 may include a processor 910, and a memory 920. The processor 910 and the memory 920 may send and receive data to each other through a bus 930, such as a wired bus and/or a wireless bus.

The security system 900 according to some example embodiments may be implemented in various electronic devices such as smartphones, tablets, laptops, PCs, smart TVs, smart home appliances, wearable devices, healthcare devices, servers, and navigation systems.

The processor 910 may control overall operations of the security system 900. The processor 910 may include one or more a central processing unit (CPU), a controller, an application processor (AP), a microprocessor unit (MPU)), a communication processor (CP), a graphic processing unit (GPU), a vision processing unit (VPU), a neural processing unit (NPU), or an ARM processor.

According to some example embodiments, the processor 910 may include the security device 100B. Here, the security device 100B illustrated in FIG. 9 may be understood as an example of the security device 100 illustrated in FIG. 1. Moreover, the security device 100B illustrated in FIG. 9 may be understood to have substantially the same configuration as the security device 100A illustrated in FIG. 8.

Accordingly, the security device 100B may perform a calculation (e.g., an integer multiplication calculation) for implementing an encryption algorithm by using the Montgomery multiplier 120. The security device 100B may refer to an accelerator for various calculations performed by the processor 910.

For example, the security device 100 may perform an integer multiplication calculation between the two inputs A1 and A2 through a Montgomery multiplication calculation of the Montgomery multiplier 120.

In this way, compared to a case where a separate configuration for integer multiplication calculation between the two inputs A1 and A2 is provided, the security device 100B according to some example embodiments may be implemented with a relatively small area. In some cases this may improve manufacturing and/or yield. Alternatively or additionally in some cases this may improve speed and/or power. Alternatively or additionally in some cases this may reduce costs.

The memory 920 may be used as a main memory device of the security system 900 and may include a volatile memory such as SRAM and/or DRAM. Moreover, the memory 920 may include a non-volatile memory such as flash memory, PRAM and/or RRAM.

As described above, the controller 110 according to some example embodiments may generate the two calculation inputs CA1 and CA2 by shifting the valid bits VB1 and VB2 respectively corresponding to the two inputs A1 and A2 to the left by the first calculation length CL1. Here, the calculation input CA1 may have a value obtained by multiplying the input A1 by the square root of the Montgomery constant ‘R’, and the calculation input CA2 may have a value obtained by multiplying the input A2 by the square root of the Montgomery constant ‘R’.

Furthermore, the Montgomery multiplier 120 may output the integer multiplication result ‘S’ between the two inputs A1 and A2 through the Montgomery multiplication calculation between the two calculation inputs CA1 and CA2, which are obtained by respectively multiplying the two inputs A1 and A2 by the square root of the Montgomery constant ‘R’.

For example, the security device 100 may perform an integer multiplication calculation between the two inputs A1 and A2 by using a Montgomery multiplication calculation of the Montgomery multiplier 120.

In this way, compared to a case where a separate configuration for integer multiplication calculation between the two inputs A1 and A2 is provided, the security device 100 according to some example embodiments may be implemented with a relatively small area.

Also, the security device 100 according to some example embodiments may perform an integer multiplication calculation between the two inputs A1 and A2 by performing a Montgomery multiplication calculation once.

Accordingly, compared to the case where the security device 100 converts one of the two inputs A1 and A2 to the Montgomery domain by using the square of the Montgomery constant ‘R’ and performs a Montgomery multiplication calculation between the converted input and the other input, the security device 100 may perform an integer multiplication calculation in a relatively short time.

For example, the security device 100 according to some example embodiments may reduce the time required to perform an integer multiplication calculation by using a Montgomery multiplication calculation.

Moreover, the security device 100 according to some example embodiments may perform an integer multiplication calculation between the two inputs A1 and A2 by using the internal Montgomery multiplier 120 without any intervention of hardware or software outside the security device 100.

In this way, the security device 100 may improve the security of the encryption algorithm implemented through the security device 100.

Alternatively or additionally, when the length of each chunk of the two inputs A1 and A2 increases, the security device 100 according to some example embodiments may limit the valid length in a Montgomery multiplication calculation based on the increase amount of a chunk length.

In this way, the security device 100 according to some example embodiments may reduce the possibility of overflow of a bit occurring in an operation process between the first input A1 and the second input A2. Accordingly, the security device 100 may improve the accuracy of the integer multiplication calculation.

Example embodiments in which a design is changed simply or which are easily changed may be included as well as example embodiments described above. In addition, technologies that are easily changed and implemented by using the above embodiments may be included in example embodiments. Accordingly, it will be apparent to those of ordinary skill in the art that various changes and modifications may be made to the above embodiments without departing from the spirit and scope of the present disclosure as set forth in the following claims.

A security device according to some example embodiments may reduce the time required to perform an integer multiplication calculation.

Accordingly, some example embodiments may improve, e.g., may double, the precision of a Montgomery modular multiplier or Montgomery reduction, and perform an integer multiplication calculation while a valid length of an operand is half the length of the operation, thereby performing an integer multiplication calculation in a relatively short time.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While inventive concepts have been described with reference to embodiments thereof, it will be apparent to those of ordinary skill in the art that various changes and modifications may be made thereto without departing from the spirit and scope of the present disclosure as set forth in the following claims. Additionally, example embodiments are not necessarily mutually exclusive with one another. For example, some example embodiments may include one or more features described with reference to one or more figures, and may also include one or more other features described with reference to one or more other figures.

What is claimed is:

1. A security device comprising:
a controller configured to generate a first calculation input from a first input having a first calculation length, the first calculation input having a second calculation length, which is greater than or equal to twice the first calculation length, and to generate a second calculation input having the second calculation length from a second input having the first calculation length; and
a Montgomery multiplier configured to output an integer multiplication result between the first input and the second input based on a Montgomery multiplication between the first calculation input and the second calculation input,
wherein the controller is configured to,
generate a first medium input having the second calculation length by adding a plurality of first upper bits to the first input
generate a second medium input having the second calculation length by adding a plurality of second upper bits to the second input,
generate the first calculation input by shifting bits of the first medium input to a left by the first calculation length, and
generate the second calculation input by shifting bits of the second medium input to the left by the first calculation length.

2. The security device of claim 1, wherein a modulus value corresponding to a maximum value of a value output through the Montgomery multiplier is greater than a value obtained by multiplying a maximum value of the first calculation input and a maximum value of the second calculation input.

3. The security device of claim 1, wherein the controller is configured to:
shift first valid bits included in the first input among the first medium input to the left by the first calculation length; and
generate the first calculation input by adding first lower bits having the first calculation length,
wherein a bit value of each of the first lower bits is 0.

4. The security device of claim 3, wherein a bit value of each of the plurality of first upper bits is 1 in response to a corresponding sign-bit among the first valid bits being 1, and is 0 in response to a corresponding sign-bit among the first valid bits is 0.

5. The security device of claim 3, wherein
in response to a length of a chunk, which is a calculation unit of each of the first input and the second input, increasing by a first additional length:
the first valid bits among the first medium input have a length obtained by subtracting the first additional length from the first calculation length, and
second valid bits included in the second input among the second medium input have a length obtained by subtracting the first additional length from the first calculation length.

6. The security device of claim 5, wherein in response to a length of a chunk of each of the first input and the second input increasing by a second additional length:
the first valid bits of the first medium input have a length obtained by subtracting twice the second additional length from the first calculation length, and
the second valid bits of the second medium input have a length equal to the first calculation length.

7. The security device of claim 5, wherein the security device is configured to obtain the integer multiplication result between the first input and the second input by summing the first valid bits and the second valid bits, the summing being result valid bits.

8. The security device of claim 1, wherein
the Montgomery multiplier is configured to output the integer multiplication result by multiplying a reciprocal of a Montgomery constant and a result of multiplication between the first calculation input and the second calculation input in a Montgomery domain, and
wherein the Montgomery constant has a base of 2 and an exponent of twice the first calculation length.

9. The security device of claim 3, further comprising:
a bit shifter configured to shift bits of input data to the left by a specified number of bits,
wherein the bit shifter is configured to shift the first valid bits to the left by the first calculation length.

10. The security device of claim 1, wherein the controller is configured to generate a signature according to at least one of an RSA algorithm, an elliptic curve digital signature algorithm (ECDSA), an Edwards-curve digital signature algorithm (EdDSA), and a post-quantum algorithm, by using the integer multiplication result.

11. A method of performing an integer multiplication calculation in a security device, the method comprising:
generating a first medium input from a first input having a first calculation length, the first medium input having a second calculation length, which is greater than or equal to twice the first calculation length;
generating a second medium input having the second calculation length from a second input having the first calculation length;
generating a first calculation input by shifting first valid bits of the first input among the first medium input to a left by the first calculation length;
generating a second calculation input by shifting second valid bits of the second input among the second medium input to the left by the first calculation length; and
outputting, by a Montgomery multiplier, an integer multiplication result between the first input and the second input based on a Montgomery multiplication between the first calculation input and the second calculation input.

12. The method of claim 11, wherein the generating of the first medium input further includes:
generating the first medium input by adding a plurality of first upper bits to the first input,
wherein each of the plurality of first upper bits has a value according to a sign of each of bits included in the first input.

13. The method of claim 11, wherein the generating of the first calculation input further includes:
adding first lower bits having the first calculation length,
wherein a value of each of the first lower bits is 0.

14. The method of claim 11, wherein a modulus value corresponding to a maximum value of a value output through the Montgomery multiplier is greater than a value obtained by multiplying a maximum value of the first calculation input and a maximum value of the second calculation input.

15. The method of claim 11, wherein in response to a length of a chunk, which is a calculation unit of each of the first input and the second input, increasing by a first additional length:
the first valid bits among the first medium input have a length obtained by subtracting the first additional length from the first calculation length, and
the second valid bits among the second medium input have a length obtained by subtracting the first additional length from the first calculation length.

16. The method of claim 15, wherein in response to a length of a chunk of each of the first input and the second input increasing by a second additional length:
the first valid bits of the first medium input have a length obtained by subtracting twice the first additional length from the first calculation length, and
the second valid bits of the second medium input have a length equal to the first calculation length.

17. A security device comprising:
a controller configured to generate a first calculation input from a first input having a first calculation length, and to generate a second calculation input from a second input having the first calculation length; and
a Montgomery multiplier configured to output an integer multiplication result between the first input and the second input based on a Montgomery multiplication between the first calculation input and the second calculation input,
wherein the first input includes first valid bits corresponding to a first valid length smaller than or equal to half of the first calculation length,
wherein the second input includes second valid bits corresponding to the first valid length, and
wherein the controller is configured to:
generate the first calculation input by shifting the first valid bits to a left by the first valid length; and
generate the second calculation input by shifting the second valid bits to the left by the first valid length.

18. The security device of claim 17, wherein a modulus value corresponding to a maximum value of a value output through the Montgomery multiplier is greater than a value obtained by multiplying a maximum value of the first calculation input and a maximum value of the second calculation input.

19. The security device of claim 17, wherein the controller is configured to:
shift the first valid bits to the left by the first valid length; and
generate the first calculation input by adding first lower bits having the first valid length, and
wherein a bit value of each of the first lower bits is 0.

20. The security device of claim 17, wherein the integer multiplication result between the first input and the second input includes result valid bits obtained by summing the first valid bits and the second valid bits.
